(19) United States
(12) Patent Application Publication
(10) Pub. No.: US 2025/0322587 A1
(43) Pub. Date: Oct. 16, 2025

(54) IMAGE RENDERING PROCESSING METHOD AND APPARATUS, DEVICE, AND MEDIUM

(71) Applicant: Beijing Zitiao Network Technology Co., Ltd., Haidian District, Beijing (CN)

(72) Inventor: Xubin ZHOU, Beijing (CN)

(21) Appl. No.: 18/866,339

(22) PCT Filed: May 15, 2023
(86) PCT No.: PCT/CN2023/094204

§ 371 Date: Nov. 15, 2024

(30) Foreign Application Priority Data
May 19, 2022 (CN) 202210557102.8

(51) Int. Cl. G06T 15/04

(52) U.S. Cl. CPC G06T 15/04

(57) ABSTRACT

Embodiments of the present disclosure relate to an image rendering processing method and apparatus, a device, and a medium. The method comprises: in response to a special effect display request for a target object in an original image, obtaining a three-dimensional model of the target object; on the basis of the three-dimensional model of the target object and a target texture image, generating a two-dimensional texture image corresponding to the target object; rendering the two-dimensional texture image by means of a target material to generate a two-dimensional target image; and overlapping the two-dimensional target image with the original image to display a special effect image of the target object.

### CROSS-REFERENCE TO RELATED APPLICATIONS

This application is based on and claims the benefit of priority to the Chinese patent application No. 202210557102.8 filed on May 19, 2022, which is hereby incorporated by reference in its entirety into the present application.

### TECHNICAL FIELD

The present disclosure relates to the field of image processing technology, in particular to an image rendering processing method and apparatus, a device and a medium.

### BACKGROUND

With the rapid development of Internet technology and smart terminals, the interaction between the user and the smart device is becoming more and more diversified by image processing such as beautification and stylization.

In the related art, various effects may be simulated by adding two-dimensional effect elements to a two-dimensional image, for example, effects such as mist, water droplet, love and flame may be generated at the edge of a figure in the two-dimensional image.

### SUMMARY

According to some embodiments of the present disclosure, an image rendering processing method is provided, the method comprising:
obtaining a three-dimensional model of the target object in response to an effect display request for a target object in an original image;
generating a two-dimensional texture image corresponding to the target object based on a three-dimensional model of the target object and a target texture image;
rendering the two-dimensional texture image by a target material to generate a two-dimensional target image; and
coinciding the two-dimensional target image with the original image to display an effect image of the target object.

According to other embodiments of the present disclosure, an image rendering processing apparatus is also provided, the apparatus comprising:
a request module configured to obtain a three-dimensional model of the target object in response to an effect display request for a target object in an original image;
an image module configured to generate a two-dimensional texture image corresponding to the target object based on a three-dimensional model of the target object and a target texture image;
a rendering module configured to render the two-dimensional texture image by a target material to generate a two-dimensional target image; and
a coinciding module configured to coincide the two-dimensional target image with the original image to display an effect image of the target object.

According to still other embodiments of the present disclosure, an electronic device is also provided, the electronic device comprising: a processor; a memory for storing instructions executable by the processor; the processor is configured to read the executable instruction from the memory and execute the instructions to implement the image rendering processing method provided by any of the embodiments of the present disclosure.

According to yet other embodiments of the present disclosure, a computer-readable storage medium is also provided, the storage medium stores a computer program for performing the image rendering processing method provided by any of the embodiments of the present disclosure.

According to still other embodiments of the present disclosure, a computer program is provided, the computer program comprising: instructions that, when executed by a processor, implement the image rendering processing method provided by any of the embodiments of the present disclosure.

### BRIEF DESCRIPTION OF THE DRAWINGS

The above-described and other features, advantages and aspects of embodiments of the present disclosure will become more apparent in conjunction with the accompanying drawings and with reference to the following detailed description. Throughout the accompanying drawings, the same or similar reference numerals indicate the same or similar elements. It should be understood that the accompanying drawings are schematic, and the members and elements are not necessarily drawn to scale.

FIG. 1 is a flowchart of an image rendering processing method provided by some embodiments of the present disclosure;

FIG. 2 is a schematic view of a three-dimensional model provided by some embodiments of the present disclosure;

FIG. 3 is a schematic view of a three-dimensional texture model provided by some embodiments of the present disclosure;

FIG. 4 is a schematic view of a two-dimensional texture image provided by some embodiments of the present disclosure;

FIG. 5 is a schematic view of a two-dimensional target image provided by some embodiments of the present disclosure;

FIG. 6 is a schematic view of an effect image provided by some embodiments of the present disclosure;

FIG. 7 is a flowchart of another image rendering processing method provided by some embodiments of the present disclosure;

FIG. 8 is a schematic view of another effect image provided by some embodiments of the present disclosure;

FIG. 9 is a schematic structural view of an image rendering processing apparatus provided by some embodiments of the present disclosure;

FIG. 10 is a schematic structural view of an electronic device provided by some embodiments of the present disclosure.

### DETAILED DESCRIPTION

The embodiments of the present disclosure will be described in more detail with reference to the accompanying drawings below. Although the accompanying drawings illustrate some embodiments of the present disclosure, it should be understood that the present disclosure may be implemented in various forms, and should not be construed as being limited to the embodiments set forth herein; rather, these embodiments are intended for a more thorough and complete understanding of the present disclosure. It should be understood that the accompanying drawings and embodiments of the present disclosure are only for illustrative purposes, rather than for limiting the protection scope of the present disclosure.

It should be understood that the various steps recited in the method embodiments of the present disclosure may be performed according to different sequences, and/or performed in parallel. In addition, the method embodiments may comprise additional steps and/or omit to perform the illustrated steps. The scope of the present disclosure is not limited in this respect.

As used herein, the term “comprising” and its variants are open-ended inclusion, that is, “comprising but not limited to”. The term “based on” means “at least partially based on”. The term “one embodiment” means “at least one embodiment”; the term “another embodiment” means “at least one additional embodiment”; and the term “some embodiments” means “at least some embodiments”. The related definitions of other terms will be given in the following description.

It should be noted that the concepts such as “first” and “second” mentioned in the present disclosure are only used to distinguish different devices, modules or units, but not to limit the order or interdependence of functions performed by these devices, modules or units.

It should be noted that the modifications of “one” and “a plurality of” mentioned in the present disclosure are illustrative rather than restrictive, and those skilled in the art should understand that they should be understood as “one or more” unless contextually specified otherwise.

The names of messages or information exchanged between multiple devices in the embodiments of the present disclosure are only used for illustrative purposes, but not for limiting the scope of these messages or information.

The inventors have found that, when effects are added to image rendering in the related art, there is a limited effect with deficient stereoscopic effect and vividness, which results in poor user experience.

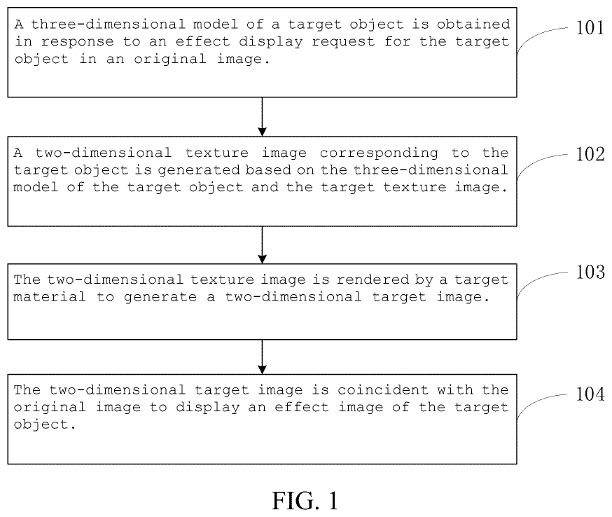

FIG. 1 is a flowchart of an image rendering processing method provided by some embodiments of the present disclosure, which may be performed by an image rendering processing apparatus, wherein the apparatus may be implemented by software and/or hardware, and may generally be integrated in the electronic device. As shown in FIG. 1, the method comprises steps 101 to 104.

In Step 101, a three-dimensional model of a target object is obtained in response to an effect display request for the target object in an original image.

The target object may be a subject that is currently subjected to image capturing and effect experience, and the type and quantity of the target object may be determined according to actual conditions, for example, the target object may be human or animal. The three-dimensional model may be computer data composed of basic graphic elements (points, lines and planes) to restore the visual representation of the three-dimensional object in the real world, which may be specifically constructed and generated in a three-dimensional modeling tool. The effect display request may be a request for effect display of the target object in an original image obtained based on a trigger operation of a current user.

Specifically, the image rendering processing apparatus may detect a trigger operation of a current user, and after a trigger operation of a current user on a material control is detected, it may be determined that a request for effect display of the target object in an original image is received, wherein the material control may be set according to actual conditions, which is not specifically limited; then, a three-dimensional model of the target object may be obtained, and the obtaining method is not limited.

In some embodiments, the obtaining a three-dimensional model of the target object may comprise: obtaining the object attributes of the target object in an original image; querying a preset three-dimensional model database to obtain a three-dimensional model corresponding to the object attributes.

The original image may be an initial image comprising a target object without any processing to be performed. The object attributes may be particular attributes representative of the target object; for example, when the target object is a person, the object attributes may be gender, hair length and other attributes. The three-dimensional model database may be a database constructed in advance which comprises three-dimensional general models of various objects or subjects.

When a three-dimensional model of the target object is obtained, the image rendering processing apparatus may identify a target image in an original image and determine the object attributes of the target object, and then determine and obtain a three-dimensional model corresponding to the object attributes of the target object by searching in the preset three-dimensional model database based on the object attributes of the target object. In the above-described solution, the three-dimensional model may be obtained directly based on the preset three-dimensional model database, which may improve the efficiency of obtaining the three-dimensional model.

In other embodiments, the obtaining a three-dimensional model of the target object may comprise: tracking a target area of a target object in the original image to generate a three-dimensional model of the target area, wherein the three-dimensional model of the target area comprises: a local three-dimensional model of the target object or a global three-dimensional model of the target object.

The target area may be a local area of interactive attention of the target object in an original image; for example, when the target object is a person, the target area may comprise but is not limited to a face area, a shoulder area, a limbs area and the like.

When a three-dimensional model of the target object is obtained, the image rendering processing apparatus may also track a target area of the target image in an original image in real time, and then process by using a transformation algorithm from a two-dimensional image to a three-dimensional model to generate a local three-dimensional model of the target object, that is, a local three-dimensional model comprising only a target area, or generate a global three-dimensional model of the target object. The above-described transformation algorithm from a two-dimensional image to a three-dimensional model may comprise a plurality of algorithms, and the embodiment of the present disclosure is not limited thereto, for example, a deep learning algorithm or a displacement transformation algorithm may be used. In the above-described solution, the three-dimensional model may be more conformed to an object of an actual scene by generating a three-dimensional model in real time, thereby improving the accuracy of the three-dimensional model.

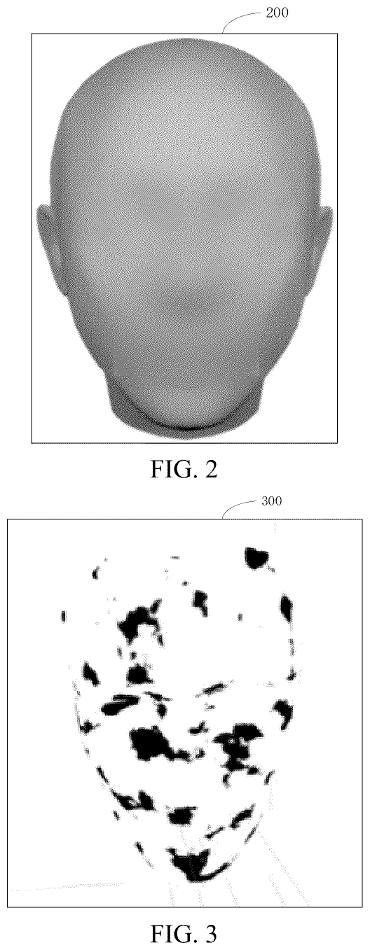

For example, FIG. 2 is a schematic view of a three-dimensional model provided by some embodiments of the present disclosure. As shown in FIG. 2, an exemplary three-dimensional model 200 where the target object is a person is displayed.

In Step 102, a two-dimensional texture image corresponding to the target object is generated based on the three-dimensional model of the target object and the target texture image.

The texture image may be an image representative of the texture of an object surface in a general sense, for example, the texture image may comprise rugged grooves or chromatic patterns and the like, which is not specifically limited. The target texture image may be a texture image corresponding to a subsequent target material, and the target material may be a two-dimensional effect material in some embodiments of the present disclosure. For example, when the target material is a flame effect, the target texture image may be a texture image with a preset texture, and the preset texture may be set according to actual conditions. For example, the preset texture may comprise a color area texture, a pattern area texture, and the like. The two-dimensional texture image may be an image obtained by adding a texture of the target texture image on the basis of the three-dimensional model and then projecting the same onto a two-dimensional plane.

In some embodiments of the present disclosure, the generating the two-dimensional texture image corresponding to a target object based on the three-dimensional model of the target object and the target texture image may comprise: conforming the three-dimensional model to the target texture image to generate a three-dimensional texture model; and mapping the three-dimensional texture model to a target position corresponding to the target object in a screen, so as to draw and generate a two-dimensional texture image according to the target position.

The target position may be a specific position of the target object when the original image is displayed in a screen, and the target position may be an area range, which may be specifically representative of the coordinates of a plurality of points. The two-dimensional texture image may be a two-dimensional image obtained by projecting the three-dimensional texture model onto a two-dimensional plane, that is, an image obtained by planarizing the three-dimensional texture model.

Specifically, after a three-dimensional model of the target object is obtained, the image rendering processing apparatus may conform the target texture image on the basis of the three-dimensional model so as to obtain the three-dimensional texture model. It may be understood that, the three-dimensional texture model may be static or dynamic, which is not specifically limited. After the three-dimensional texture model is generated, the target position corresponding to the target in an original image may be identified first, and specifically confirmed by image recognition; then, the above-described three-dimensional texture model may be mapped to the target position of the target object in a screen by using the mapping algorithm from three-dimension to two-dimension, and a two-dimensional texture image may be drawn and generated according to the mapped data on the target position, so that the three-dimensional texture model may be displayed in a two-dimensional form through the two-dimensional texture image.

The above-described mapping algorithm from three-dimension to two-dimension may comprise a plurality of algorithms, for example, comprising but not limited to coordinate transformation, rasterization, lighting and shading, and the like, wherein coordinate transformation may be mapping based on a coordinate transformation relationship between three-dimensional stereo coordinates and two-dimensional planar coordinates, and rasterization refers to the process of projecting points on the model of real number space to discrete pixel points of the two-dimensional plane.

In some embodiments, in the case where the three-dimensional texture model is a head texture model of a body, wherein the mapping the three-dimensional texture model to a target position corresponding to a target object in a screen so as to draw and generate a two-dimensional texture image according to the target position comprises: mapping the head texture model of a body to a target position corresponding to a head of a body in an original image in a screen according to a coordinate transformation relationship between three-dimensional stereo coordinates and two-dimensional planar coordinates so as to draw a two-dimensional head texture image of a body according to the target position.

The head texture model of a body may be a head model of a body with a preset texture, and the preset texture may be set according to actual conditions; for example, the preset texture may comprise a color area texture, a pattern area texture and the like, wherein the color area texture may be understood as a texture where different areas are filled with different colors, and the size and position of the area and the setting of the color may be determined according to actual conditions. For example, a black and white texture may be understood as a texture where some areas are filled with a black color and some areas are filled with a white color. The pattern area texture may be understood as a texture where different areas are filled with different patterns, wherein the size and position of the area and the setting of the pattern may be set according to actual conditions, for example, the pattern may comprise triangle, circle, quadrangle, and the like.

When the three-dimensional texture model is a head texture model of a body, taking the use of a coordinate transformation method when a two-dimensional texture image is generated based on the three-dimensional texture model as an example, the coordinate transformation relationship between three-dimensional stereo coordinates and two-dimensional planar coordinates indicates that a coordinate point of two-dimensional planar coordinates corresponds to a coordinate point of three-dimensional stereo coordinates in the three-dimensional texture model; by way of coordinate transformation, the head texture model of a body may be mapped or projected to a target position corresponding to a head of a body in an original image in a screen, and then a two-dimensional head texture image of a body with the above-described preset texture may be drawn and obtained according to the coordinate data after mapping to the target position. In the above-described solution, the head texture model of a body may be rapidly mapped to the target position on the two-dimensional screen by using a coordinate transformation method, so as to draw the two-dimensional head texture image of a body.

For example, FIG. 3 is a schematic view of a three-dimensional texture model provided by some embodiments of the present disclosure; as shown in FIG. 3, a three-dimensional texture model 300 obtained after conforming the target texture image of the black and white texture to the three-dimensional model of FIG. 2 is displayed by taking a preset texture which is a black and white texture as an example, wherein the texture on the surface of the three-dimensional model of FIG. 2 is shifted to the black and white texture in the three-dimensional texture model 300.

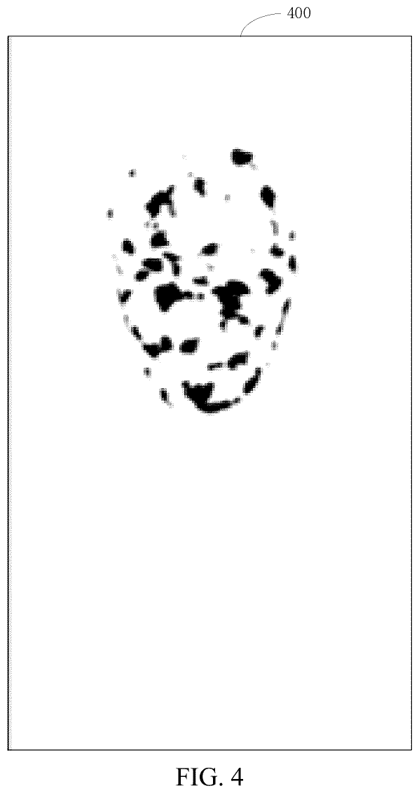

For example, FIG. 4 is a schematic view of a two-dimensional texture image provided by some embodiments of the present disclosure; as shown in FIG. 4, a two-dimensional texture image 400 with a black and white texture is displayed by taking a preset texture which is a black and white texture as an example, which is only an example.

In Step 103, the two-dimensional texture image is rendered by the target material to generate a two-dimensional target image.

The target material may be an effect material for adding an effect, for addition on the two-dimensional image, and the target material may be determined according to the user's selection or actual conditions. For example, the target material may comprise a water droplet effect material, a love effect material, a cloud effect material, a mist effect material, a flame effect material and the like.

Specifically, after a two-dimensional texture image is generated, the image rendering processing apparatus may determine the target material in response to the trigger operation, and then add the target material to some areas or all the areas in the two-dimensional texture image so as to obtain the two-dimensional target image by rendering, wherein the specific rendered area may be determined according to a specific texture of the two-dimensional texture image. For example, when the two-dimensional texture image has a red and blue texture, the target material may be rendered in a red area or a blue area to obtain a two-dimensional target image; for another example, when the two-dimensional texture image has a triangular or rectangular texture, the target material may be rendered in the triangular area or the rectangular area therein to obtain a two-dimensional target image, which is only an example.

In some embodiments, when the two-dimensional texture image is a two-dimensional texture image with a black and white texture, the rendering the two-dimensional texture image by the target material to generate the two-dimensional target image may comprise: rendering a white area in the two-dimensional texture image with a black and white texture by a target material to generate the two-dimensional target image; or, rendering a black area in the two-dimensional texture image with a black and white texture by a target material to generate a two-dimensional target image.

When the two-dimensional texture image has a black and white texture, the image rendering processing apparatus may add the target material in the white area or the black area of the two-dimensional texture image and generate the two-dimensional target image by rendering.

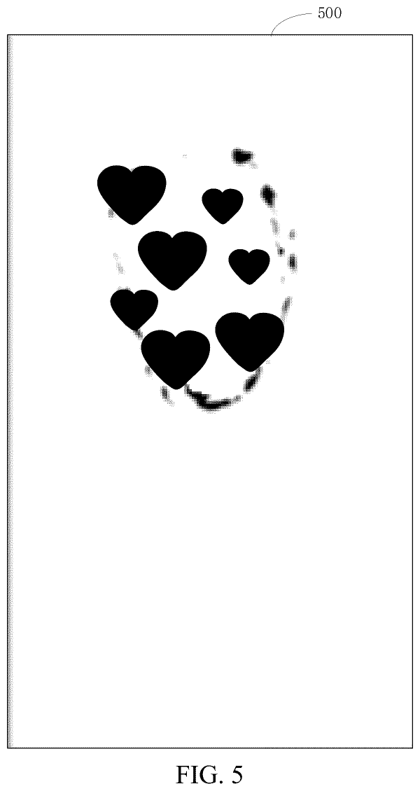

For example, FIG. 5 is a schematic view of a two-dimensional target image provided by some embodiments of the present disclosure; as shown in FIG. 5, a two-dimensional target image 500 is displayed by taking a target material which is a love effect material as an example, wherein the two-dimensional texture image corresponding to the two-dimensional target image 500 is the two-dimensional texture image 400 with a black and white texture in FIG. 4, the target material is the love effect material, and the love effect material is rendered in a black area in the two-dimensional texture image 400 to obtain the two-dimensional target image 500, which is only an example.

In Step 104, the two-dimensional target image is coincident with the original image to display an effect image of the target object.

After the image rendering processing apparatus generates a two-dimensional target image by rendering the two-dimensional texture image by the target material, since the position where the target material is added in the two-dimensional target image is the target position corresponding to the target object, the two-dimensional target image may be directly coincident or superimposed with the original image to obtain an effect image which realizes the effect of three-dimensional vision at the target object.

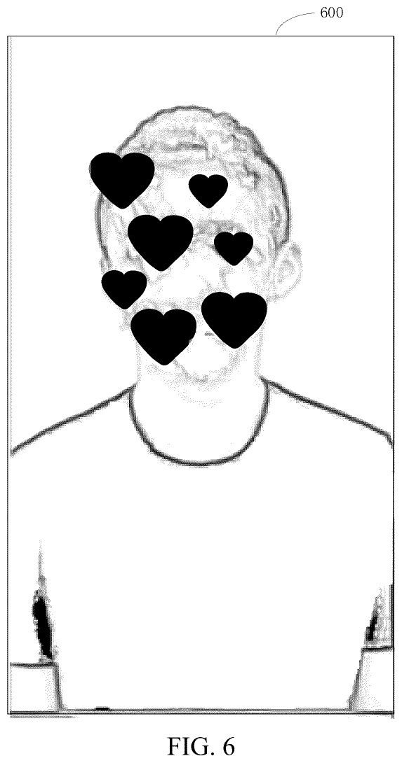

For example, FIG. 6 is a schematic view of an effect image provided by some embodiments of the present disclosure; as shown in FIG. 6, an effect image 500 with a three-dimensional vision is displayed, in which a target object is a person; the effect image 600 is obtained by coinciding the two-dimensional target image 500 of FIG. 5 with an original image comprising a person, and the love effect is displayed in a head area of a body in the effect image 600, which is only an example, and the love effect may also be displayed in the entire body area.

According to the image rendering processing solution provided by some embodiments of the present disclosure, a three-dimensional model of a target object is obtained in response to an effect display request for the target object in an original image; a two-dimensional texture image corresponding to the target object is generated based on the three-dimensional model of the target object and the target texture image; the two-dimensional texture image is rendered by the target material to generate a two-dimensional target image; the two-dimensional target image is coincident with the original image to display an effect image of the target object. By using the above-described technical solution, a two-dimensional texture image may be generated based on a three-dimensional model of an object and a texture image, and then an effect image with a three-dimensional visual effect may be displayed by coinciding the generated two-dimensional texture image after rendering by the effect material with the original image, so as to realize the three-dimensional visual presentation of the two-dimensional effect material; by way of the transformation processing from the three-dimensional model to the two-dimensional image, compared with direct processing on the two-dimensional image in the related art, the effect is more stereoscopic and also more vivid, thereby improving the effect experience of the user.

In some embodiments, before the three-dimensional texture model is generated by conforming the three-dimensional model to the target texture image, there may also comprise: setting one or more groups of pixel transparent channel information according to an effect requirement; and generating one or more corresponding target texture images with a plurality of color area textures and/or a plurality of pattern area textures accord to the one or more groups of pixel transparent channel information.

The transparent channel, which is also referred to as Alpha channel, represents the transparent information of a pixel in the image; the Alpha channel may be an 8-bit grayscale channel, which records the transparency information in the image with 256 grayscale levels so as to define a transparent, opaque or translucent area, wherein white means opaque, black means transparent and gray means translucent. A group of pixel transparent channel information may represent the transparent information of a plurality of pixel points of an image, and a plurality of groups of pixel transparent channel information have different transparent information at different pixel points.

The color area texture may be understood as a texture where different areas are filled with different colors, and the size and position of the area and the setting of the color may be determined according to actual conditions, for example, the black and white texture may be understood as a texture where some areas are filled with a black color and some areas are filled with a white color; the pattern area texture may be understood as a texture where different areas are filled with different patterns, and the size and position of the area and the setting of the pattern may be set according to actual conditions, for example, the pattern may comprise a triangle, a circle, a quadrangle and the like.

Before the above-described step 101, the image rendering processing apparatus may obtain an effect requirement set in advance, and automatically generate one or more groups of pixel transparent channel information according to an effect requirement; and then generate corresponding target texture images with a plurality of color area textures and/or a plurality of pattern area textures according to each group of pixel transparent channel information, so as to finally obtain one or more target texture images, and the specific textures of different target texture images may have different settings. In the above-described solution, one or more texture images are generated in advance, which helps to subsequently obtain a two-dimensional texture image rapidly.

In some embodiments, the generating a three-dimensional texture model by conforming the three-dimensional model to a target texture image comprises: obtaining a texture change mode, wherein the texture change mode is associated with the target texture image of different times and corresponding changes; and conforming the three-dimensional model to a target texture image with corresponding settings at different times to generate a dynamically changing three-dimensional texture model according to a texture change mode.

The texture change mode may be representative of the law of dynamic texture changes, and the law of texture changes may be representative of the temporal law of the changes and the target texture images corresponding to different times. The temporal law may be a periodic change based on a preset time period or a random temporal change, wherein the above-described preset time period may be a time interval of the texture change set in advance, which may be specifically set according to actual conditions. For example, the time period may be set to be a fixed 1/20 second. The texture change mode may be set to be a plurality of modes in advance, and different texture change modes may have different time periods and corresponding target texture images.

On the basis of the above-described a plurality of target texture images with a plurality of color area textures and/or a plurality of pattern area textures, when a three-dimensional texture model is generated by conforming the three-dimensional model to the target texture image, the image rendering apparatus may determine a current texture change mode based on a trigger operation of the user, determine the target texture images set at different times based on the texture change mode, and conform the three-dimensional model to corresponding target texture images at different times. That is, the three-dimensional model is periodically or randomly conformed to a plurality of target texture images in the form of sequence frames to generate a three-dimensional texture model, wherein the three-dimensional texture model will have a texture change every interval of a fixed or dynamically changing time period, so that the three-dimensional texture model changes dynamically.

In the above-described solution, after a plurality of target texture images are generated according to an effect requirement, the three-dimensional model may be conformed to a plurality of target texture images for multiple times in the form of sequence frames to generate a dynamically changing three-dimensional texture model, which improves the diversity of the three- dimensional texture model and allows that subsequent effects are more flexibly and vividly added.

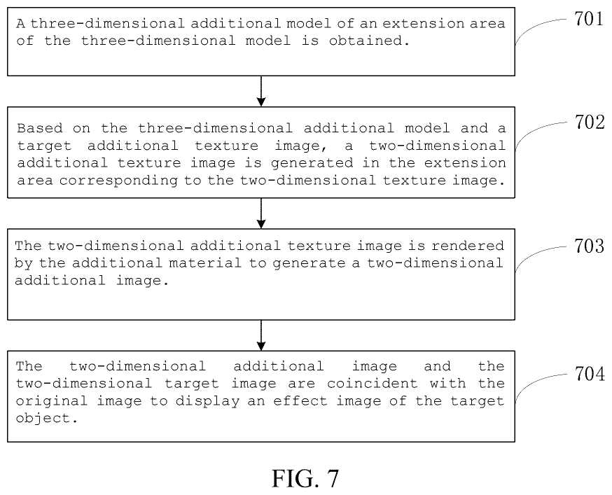

For example, FIG. 7 is a flowchart of another image rendering processing method provided by some embodiments of the present disclosure; as shown in FIG. 7, in an applicable embodiment, the image rendering processing method may further comprise: steps 701 to 704.

In Step 701, a three-dimensional additional model of an extension area of the three-dimensional model is obtained.

The extension area may be an area near the three-dimensional texture model that is required to be added with an additional effect, and the specific position may be set according to actual conditions.

When the image rendering processing apparatus obtains a three-dimensional additional model of an extension area of the three-dimensional model, one obtaining method may be to search in the preset three-dimensional model database based on the area attributes of the extension area, and to determine and obtain a three-dimensional additional model corresponding to the area attributes of the extension area; and another obtaining method may be to track the extension area, and then to process by using a transformation algorithm from a two-dimensional image to a three-dimensional model to generate a three-dimensional additional model of the extension area.

In Step 702, based on the three-dimensional additional model and a target additional texture image, a two-dimensional additional texture image is generated in the extension area corresponding to the two-dimensional texture image.

The target additional texture image may be a texture image with an additional texture, and the additional texture may be the same as or different from a preset texture of the above-described target texture image, which is not specially limited. The two-dimensional additional texture image may be an image projected onto a two-dimensional plane after adding an additional texture of the target additional texture image on the basis of the three-dimensional additional model.

In some embodiments of the present disclosure, the generating a two-dimensional additional texture image in an extension area corresponding to the two-dimensional texture image based on the three-dimensional additional model and a target additional texture image may comprise: generating a three-dimensional additional texture model by conforming the three-dimensional additional model to the target additional texture image; and mapping the three-dimensional additional texture model into the extension area corresponding to the two-dimensional texture image in a screen to generate the two-dimensional additional texture image.

The extension area corresponding to the two-dimensional texture image may be a two-dimensional area corresponding to the extension area of the above-described three-dimensional texture model, which may be an area near the above-described target object that is required to be added with an additional effect; for example, the extension area corresponding to the two-dimensional texture image may be an upper fixed area of the target object.

Specifically, after a three-dimensional additional model is obtained, the image rendering processing apparatus may conform the above-described two-dimensional additional texture image to the three-dimensional additional model to generate a three-dimensional additional texture model; and then map the three-dimensional additional texture model into the extension area corresponding to the two-dimensional texture image in a screen, wherein the mapping method is the same as that of the three-dimensional texture model in the above-described Step 102, which will not be described in detail here, so as to finally generate the two-dimensional additional texture image.

In Step 703, the two-dimensional additional texture image is rendered by the additional material to generate a two-dimensional additional image.

The additional material which may be used to add an additional effect, may be the same as or different from the above-described target material. After the image rendering processing apparatus generates a two-dimensional additional texture image, an additional material may be added to some areas or all the areas of the two-dimensional additional texture image to generate the two-dimensional additional image by rendering.

In Step 704, the two-dimensional additional image and the two-dimensional target image are coincident with the original image to display an effect image of the target object.

After the image rendering processing apparatus renders the two-dimensional texture image by the target material to generate a two-dimensional target image, and renders the two-dimensional additional texture image by the additional material to generate a two-dimensional additional image, the two-dimensional additional image and the two-dimensional target image may be coincident or superimposed with the original image to obtain an effect image which realizes the effect of three-dimensional vision at both the target object and the extension area.

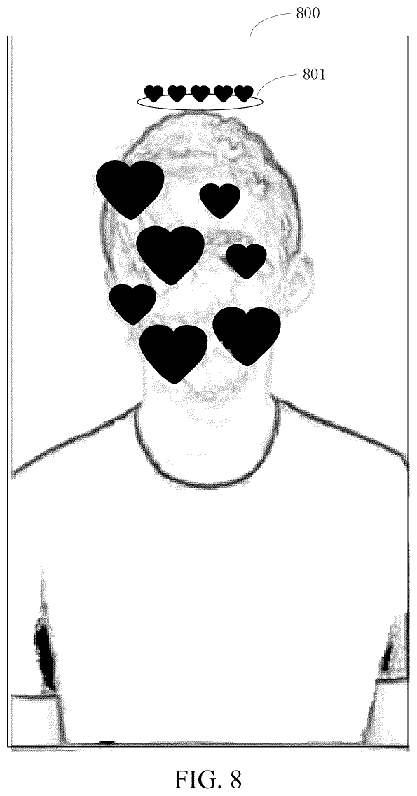

For example, FIG. 8 is a schematic view of another effect image provided by some embodiments of the present disclosure; as shown in FIG. 8, a three-dimensional visual effect image 800 is displayed, wherein, compared with the effect image 700 of FIG. 7, an additional effect 801 corresponding to a two-dimensional additional image is added to the effect image 800, and the additional material corresponding to the additional effect 801 is the same as the above-described target material, which are both a love effect material, thereby realizing a love effect. It may be understood that, the additional material of the additional effect and the position of the corresponding extension area in FIG. 8 are only examples, rather than limitations.

In the above-described solution, on the basis of realizing the three-dimensional visual presentation of a two-dimensional effect material for the target object as described above, the three-dimensional visual presentation of an additional effect material may also be realized for the extension area, so that the user may present a plurality of effects as necessary, which further improves the display flexibility of the effect, and effectively improving the effect experience by meeting more to actual requirements of the effect.

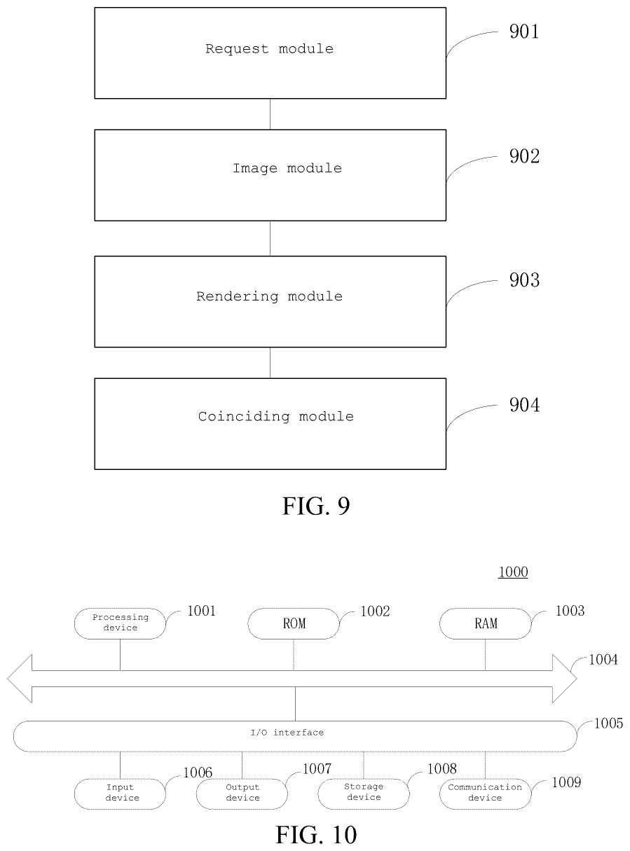

FIG. 9 is a schematic structural view of an image rendering processing apparatus provided by some embodiments of the present disclosure, which may be realized by software and/or hardware and may be generally integrated in the electronic device. As shown in FIG. 9, the device comprises:
a request module 901 configured to obtain a three-dimensional model of the target object in response to an effect display request for the target object in an original image;
an image module 902 configured to generate a two-dimensional texture image corresponding to the target object based on a three-dimensional model of the target object and a target texture image;
a rendering module 903 configured to render the two-dimensional texture image by a target material to generate a two-dimensional target image; and
a coinciding module 904 configured to coincide the two-dimensional target image with the original image to display an effect image of the target object.

In some embodiments, the request module 901 comprises a first obtaining unit configured to:
obtain the object attributes of a target object in the original image; and
query a preset three-dimensional model database to obtain a three-dimensional model corresponding to the object attributes.

In some embodiments, the request module 901 comprises a second obtaining unit configured to:
track a target area of a target object in the original image to generate a three-dimensional model of the target area, wherein the three-dimensional model of the target area comprises: a local three-dimensional model of the target object or a global three-dimensional model of the target object.

In some embodiment, that device further comprises a texture module configured to: before conforming the three-dimensional model to a target texture image to generate a three-dimensional texture model,
set one or more groups of pixel transparent channel information according to an effect requirement; and
generate one or more corresponding target texture images with a plurality of color area textures and/or a plurality of pattern area textures according to the one or more groups of pixel transparent channel information.

In some embodiments, the image module 902 comprises:
a texture unit configured to conform the three-dimensional model to the target texture image to generate a three-dimensional texture model; and
a generating unit configured to map the three-dimensional texture model to a target position corresponding to the target object in a screen, so as to draw and generate a two-dimensional texture image according to the target position.

In some embodiments, the texture unit is configured to:
obtain a texture change mode, wherein the texture change mode is associated with a target texture image of different times and corresponding changes; and
conform the three-dimensional model to a target texture image with corresponding settings at different times to generate a dynamically changing three-dimensional texture model according to the texture change mode.

In some embodiments, in the case where the three-dimensional texture model is a head texture model of a body, wherein the generating unit is configured to:
map the three-dimensional texture model to a target position corresponding to the target object in a screen;
map the head texture model of a body to a target position corresponding to a head of a body in an original image in a screen according to a coordinate transformation relationship between three-dimensional stereo coordinates and two-dimensional planar coordinates; and
draw a two-dimensional head texture image of a body according to the target position.

In some embodiments, in the case where the two-dimensional texture image is a two-dimensional texture image with a black and white texture, the rendering module 903 is configured to:
render a white area in the two-dimensional texture image with a black and white texture by a target material to generate a two-dimensional target image; or
render a black area in the two-dimensional texture image with a black and white texture by a target material to generate a two-dimensional target image.

In some embodiments, the apparatus further comprises an additional effect module configured to:
obtain a three-dimensional additional model of an extension area of the three-dimensional model; generate a two-dimensional additional texture image in an extension area corresponding to the two-dimensional texture image based on the three-dimensional additional model and a target additional texture image;
render the two-dimensional additional texture image by an additional material to generate a two-dimensional additional image; and
coincide the two-dimensional additional image and the two-dimensional target image with the original image to display an effect image of the target object.

In some embodiments, the additional effect module is configured to search in a preset three-dimensional model database based on the area attributes of an extension area, determine a three-dimensional additional model corresponding to the area attributes of the extension area, and obtain a three-dimensional additional model corresponding to the area attributes of the extension area; alternatively, the additional effect module is configured to track an extension area and process by using a transformation algorithm from a two-dimensional image to a three-dimensional model to generate a three-dimensional additional model of an extension area; alternatively, the additional effect module is configured to conform the three-dimensional additional model to the target additional texture image to generate a three-dimensional additional texture model, and map the three-dimensional additional texture model into an extension area corresponding to a two-dimensional texture image in a screen to generate a two-dimensional additional texture image.

The image rendering processing apparatus provided by the embodiment of the present disclosure may perform the image rendering processing method provided by any of the embodiments of the present disclosure, and possesses corresponding functional modules and beneficial effects to perform the method.

In some embodiments of the present disclosure, a computer program product is also provided, the computer program product comprising a computer program/instruction that, when executed by a processor, implements the image rendering processing method provided by any of the embodiments of the present disclosure.

The present disclosure further provides a computer program product comprising instruction that, when executed by a processor, implements the image rendering processing method provided by any of the embodiments of the present disclosure.

FIG. 10 is a schematic structural view of an electronic device provided by an embodiment of the present disclosure. Next, specifically refer to FIG. 10, which shows a structural schematic view of an electronic device 1000 suitable for implementing an embodiment of the present disclosure. The electronic device 1000 in the embodiment of the present disclosure may comprise, but is not limited to, mobile terminals such as mobile phones, notebook computers, digital broadcast receivers, PDA (personal digital assistant), PAD (pad computer), PMP (Portable Multimedia Player) and in-vehicle terminals (for example, in-vehicle navigation terminals); and fixed terminals such as digital TVs, desktop computers and the like. The electronic device shown in FIG. 10 is only an example, and shall not limit the functions and application range of the embodiments of the present disclosure.

As shown in FIG. 10, the electronic device 1000 may comprise a processing device (for example, a central processing unit, a graphic processor, and the like) 1001, which may perform various suitable actions and processing according to a program stored in a Read-only Memory (ROM) 1002 or a program loaded from a storage device 1008 into a Random Access Memory (RAM) 1003. In the RAM 1003, various programs and data required for the operation of the electronic device 1000 are also stored. The processing device 1001, the ROM 1002 and the RAM 1003 are connected to each other through a bus 1004. The input/output (I/O) interface 1005 is also connected to the bus 1004.

Generally, the following devices may be connected to the I/O interface 1005: an input device 1006 comprising, for example, a touch screen, a touch pad, a keyboard, a mouse, a camera, a microphone, an accelerometer, a gyroscope, and the like; an output device 1007 comprising, for example, a Liquid Crystal Display (LCD), a speaker, a vibrator, and the like; a storage device 1008 comprising, for example, a magnetic tape, a hard disk, and the like; and a communication device 1009. The communication device 1009 may allow the electronic device 1000 to be in wireless or wired communication with other devices to exchange data. Although FIG. 10 shows the electronic device 1000 with various devices, it should be understood that there is no requirement to implement or have all the devices shown. It is possible to alternatively implement or possess more or less devices.

In particular, according to an embodiment of the present disclosure, the process described above with reference to the flowchart may be implemented as a computer software program. For example, in an embodiment of the present disclosure, there comprises a computer program product, which comprises a computer program carried on a non-transient computer-readable medium, wherein the computer program contains program codes for executing the method shown in the flowchart. In such embodiment, the computer program may be downloaded and installed from the network through the communication device 1009, installed from the storage device 1008, or installed from the ROM 1002. When the computer program is executed by the processing device 1001, the above-described functions defined in the image rendering processing method of the embodiment of the present disclosure are performed.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may comprise, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, device, or apparatus or used in combination therewith. In the present disclosure, the computer-readable signal medium may comprise a data signal propagated in a baseband or as a part of a carrier wave, wherein a computer-readable program code is carried. Such propagated data signal may take many forms, comprising but not limited to an electromagnetic signal, an optical signal, or any suitable combination thereof. The computer-readable signal medium may also be any computer-readable medium other than the computer-readable storage medium, wherein the computer-readable signal medium may send, propagate, or transmit a program for use by an instruction execution system, device, or apparatus or in combination with therewith. The program code contained on the computer-readable medium may be transmitted by any suitable medium, comprising but not limited to: a wire, an optical cable, radio frequency (RF), and the like, or any suitable combination thereof.

In some embodiments, the client and the server may communicate using any currently known or future developed network protocol such as HTTP (HyperText Transfer Protocol), and may be interconnected with digital data communication in any form or medium (for example, a communication network). Examples of communication networks comprise a Local Area Network (“LAN”), a Wide Area Network (“WAN”), an extranet (for example, Internet) and an end-to-end network (for example, an ad hoc end-to-end network), as well as any currently known or future developed network.

The above-described computer-readable medium may be comprised in the above-described electronic device; or may also exist alone without being assembled into the electronic device.

The above-described computer-readable medium carries one or more programs that, when executed by the electronic device, cause the electronic device to: obtain a three-dimensional model of a target object in an original image in response to an effect display request for the target object; generate a two-dimensional texture image corresponding to the target object based on a three-dimensional model of the target object and a target texture image; render the two-dimensional texture image by a target material to generate a two-dimensional target image; and coinciding the two-dimensional target image with the original image to display an effect image of the target object.

The computer program code for performing the operations of the present disclosure may be written in one or more programming languages or a combination thereof, wherein the above-described programming languages comprise but are not limited to object-oriented programming languages, such as Java, Smalltalk, and C++, and also comprise conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In the case of a remote computer, the remote computer may be connected to the user's computer through any kind of network (comprising a local area network (LAN) or a wide area network (WAN)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession may actually be executed substantially in parallel, and may sometimes also be executed in a reverse order, depending on the functions involved. It should also be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The units involved in the described embodiments of the present disclosure may be implemented in software or hardware. Wherein, the names of the units do not constitute a limitation on the units themselves under certain circumstances.

The functions described hereinabove may be performed at least in part by one or more hardware logic components. For example, without limitation, the hardware logic components of a demonstrative type that may be used comprise: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, a machine-readable medium may be a tangible medium, which may contain or store a program for use by the instruction execution system, apparatus, or device or use in combination with the instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination thereof. More specific examples of the machine-readable storage medium may comprise an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only an explanation of preferred embodiments of the present disclosure and the applied technical principles. Those skilled in the art should understand that the scope of disclosure involved in this disclosure is not limited to the technical solutions formed by the specific combination of the above technical features, and at the same time should also cover other technical solutions formed by arbitrarily combining the above-described technical features or equivalent features without departing from the above disclosed concept. For example, a technical solution formed by the above-described features and the technical features disclosed in the present disclosure (but not limited thereto) having similar functions replacing with each other.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although the present subject matter has been described in language specific to structural features and/or methodological actions, it should be understood that the subject matter defined in the appended claims is not necessarily limited to the specific features or actions described above. On the contrary, the specific features and actions described above are only exemplary forms of implementing the claims.

1. An image rendering processing method, comprising:
obtaining, in response to an effect display request for a target object in an original image, a three-dimensional model of the target object;
generating a two-dimensional texture image corresponding to the target object based on a three-dimensional model of the target object and a target texture image;
rendering the two-dimensional texture image by a target material to generate a two-dimensional target image; and
coinciding the two-dimensional target image with the original image to display an effect image of the target object.

2. The image rendering processing method according to claim 1, wherein the obtaining a three-dimensional model of the target object comprises:
obtaining object attributes of the target object in the original image; and
querying a preset three-dimensional model database to obtain a three-dimensional model corresponding to the object attributes.

3. The image rendering processing method according to claim 1, wherein the obtaining a three-dimensional model of the target object comprises:
tracking a target area of the target object in the original image to generate a three-dimensional model of the target area, wherein the three-dimensional model of the target area comprises: a local three-dimensional model of the target object or a global three-dimensional model of the target object.

4. The image rendering processing method according to claim 1, further comprising:
setting one or more groups of pixel transparent channel information according to an effect requirement;
generating one or more corresponding target texture images with a plurality of color area textures and/or a plurality of pattern area textures according to the one or more groups of pixel transparent channel information.

5. The image rendering processing method according to claim 1, wherein the generating a two-dimensional texture image corresponding to the target object based on a three-dimensional model of the target object and a target texture image comprises:
conforming the three-dimensional model to the target texture image to generate a three-dimensional texture model; and
mapping the three-dimensional texture model to a target position corresponding to the target object in a screen, so as to draw and generate a two-dimensional texture image according to the target position.

6. The image rendering processing method according to claim 5, wherein the conforming the three-dimensional model to the target texture image to generate a three-dimensional texture model comprises:
obtaining a texture change mode, wherein the texture change mode is associated with a target texture image of different times and corresponding changes; and
conforming the three-dimensional model to a target texture image with corresponding settings at different times to generate a dynamically changing three-dimensional texture model according to the texture change mode.

7. The image rendering processing method according to claim 5, wherein in the case where the three-dimensional texture model is a head texture model of a body, the mapping the three-dimensional texture model to a target position corresponding to the target object in a screen, so as to draw and generate a two-dimensional texture image according to the target position comprises:
mapping the head texture model of a body to a target position corresponding to a head of a body in an original image in a screen according to a coordinate transformation relationship between three-dimensional stereo coordinates and two-dimensional planar coordinates; and
drawing a two-dimensional head texture image of a body according to the target position.

8. The image rendering processing method according to claim 1, wherein in the case where the two-dimensional texture image is a two-dimensional texture image with a black and white texture, the rendering the two-dimensional texture image by a target material to generate a two-dimensional target image comprises:
rendering a white area in the two-dimensional texture image with a black and white texture by a target material to generate a two-dimensional target image; or,
rendering a black area in the two-dimensional texture image with a black and white texture by a target material to generate a two-dimensional target image.

9. The image rendering processing method according to claim 1, further comprising:
obtaining a three-dimensional additional model of an extension area of the three-dimensional model;
generating a two-dimensional additional texture image in an extension area corresponding to the two-dimensional texture image based on the three-dimensional additional model and a target additional texture image;
rendering the two-dimensional additional texture image by an additional material to generate a two-dimensional additional image; and
coinciding the two-dimensional additional image and the two-dimensional target image with the original image to display an effect image of the target object.

10. The image rendering processing method according to claim 9, wherein the obtaining a three-dimensional additional model of an extension area of the three-dimensional model comprises:
searching in a preset three-dimensional model database based on the area attributes of the extension area, determining a three-dimensional additional model corresponding to the area attributes of the extension area, and obtaining a three-dimensional additional model corresponding to the area attributes of the extension area; or,
tracking the extension area, and processing by using a transformation algorithm from a two-dimensional image to a three-dimensional model to generate a three-dimensional additional model of the extension area.

11. The image rendering processing method according to claim 9, wherein the generating a two-dimensional additional texture image in an extension area corresponding to a two-dimensional texture image based on a three-dimensional additional model and a target additional texture image comprises:
conforming the three-dimensional additional model to the target additional texture image to generate a three-dimensional additional texture model; and
mapping the three-dimensional additional texture model into the extension area corresponding to the two-dimensional texture image in a screen to generate a two-dimensional additional texture image.

12-19. (canceled)

20. An electronic device, wherein the electronic device comprises:
a processor;
a memory for storing instructions executable by the processor;
the processor is configured to read the executable instruction from the memory and execute the instructions to implement an image rendering processing method comprising:
obtaining, in response to an effect display request for a target object in an original image, a three-dimensional model of the target object;
generating a two-dimensional texture image corresponding to the target object based on a three-dimensional model of the target object and a target texture image;
rendering the two-dimensional texture image by a target material to generate a two-dimensional target image; and
coinciding the two-dimensional target image with the original image to display an effect image of the target object.
material to generate a two-dimensional target image.

21. A non-transient computer-readable storage medium, wherein the storage medium stores a computer program for performing an image rendering processing method comprising:
obtaining, in response to an effect display request for a target object in an original image, a three-dimensional model of the target object;
generating a two-dimensional texture image corresponding to the target object based on a three-dimensional model of the target object and a target texture image;
rendering the two-dimensional texture image by a target material to generate a two-dimensional target image; and
coinciding the two-dimensional target image with the original image to display an effect image of the target object.

22. (canceled)

23. The electronic device according to claim 20, wherein the obtaining a three-dimensional model of the target object comprises:
obtaining object attributes of the target object in the original image; and
querying a preset three-dimensional model database to obtain a three-dimensional model corresponding to the object attributes.

24. The electronic device according to claim 20, wherein the obtaining a three-dimensional model of the target object comprises:
tracking a target area of the target object in the original image to generate a three-dimensional model of the target area, wherein the three-dimensional model of the target area comprises: a local three-dimensional model of the target object or a global three-dimensional model of the target object.

25. The electronic device according to claim 20, further comprising:
setting one or more groups of pixel transparent channel information according to an effect requirement;
generating one or more corresponding target texture images with a plurality of color area textures and/or a plurality of pattern area textures according to the one or more groups of pixel transparent channel information.

26. The electronic device according to claim 20, wherein the generating a two-dimensional texture image corresponding to the target object based on a three-dimensional model of the target object and a target texture image comprises:
conforming the three-dimensional model to the target texture image to generate a three-dimensional texture model; and
mapping the three-dimensional texture model to a target position corresponding to the target object in a screen, so as to draw and generate a two-dimensional texture image according to the target position.

27. The electronic device according to claim 26, wherein the conforming the three-dimensional model to the target texture image to generate a three-dimensional texture model comprises:
obtaining a texture change mode, wherein the texture change mode is associated with a target texture image of different times and corresponding changes; and
conforming the three-dimensional model to a target texture image with corresponding settings at different times to generate a dynamically changing three-dimensional texture model according to the texture change mode.

28. The electronic device according to claim 26, wherein in the case where the three-dimensional texture model is a head texture model of a body, the mapping the three-dimensional texture model to a target position corresponding to the target object in a screen, so as to draw and generate a two-dimensional texture image according to the target position comprises:
mapping the head texture model of a body to a target position corresponding to a head of a body in an original image in a screen according to a coordinate transformation relationship between three-dimensional stereo coordinates and two-dimensional planar coordinates; and
drawing a two-dimensional head texture image of a body according to the target position.

29. The electronic device according to claim 20, wherein in the case where the two-dimensional texture image is a two-dimensional texture image with a black and white texture, the rendering the two-dimensional texture image by a target material to generate a two-dimensional target image comprises:
rendering a white area in the two-dimensional texture image with a black and white texture by a target material to generate a two-dimensional target image; or,
rendering a black area in the two-dimensional texture image with a black and white texture by a target material to generate a two-dimensional target image.
